(19) United States
(12) Patent Application Publication
(10) Pub. No.: US 2014/0211317 A1
(43) Pub. Date: Jul. 31, 2014

(54) CONTROL CIRCUIT FOR DIMMING AN ELECTROCHROMIC MIRROR GLASS OF A REARVIEW MIRROR OF A MOTOR VEHICLE

(71) Applicant: SMR Patents S.à.r.l., Luxembourg (LU)

(72) Inventors: Rolf Thiel, Stuttgart (DE); Manfred Herrler, Schwabach (DE)

(21) Appl. No.: 13/967,868

(22) Filed: Aug. 15, 2013

Related U.S. Application Data
(62) Division of application No. 12/131,708, filed on Jun. 2, 2008, now abandoned.
Application No. 12/131,708 is a continuation of application No. 11/144,457, filed on Jun. 3, 2005, now abandoned.

(30) Foreign Application Priority Data
Jun. 5, 2004 (DE) 102004027611.0

(51) Int. Cl. B60R 1/08

(52) U.S. Cl. CPC B60R 1/08
USPC 359/604

(57) ABSTRACT

A rearview mirror incorporates the use of electrochromic mirror glass capable of dimming via electronic controls. The electrochromic mirror glass dims when glare from vehicle driving aft of the motor vehicle impinge on the rearview mirror. The rearview mirror includes a control circuit with a single sensor. The sensor receives glare from aft and ambient light forward the motor vehicle. A light conductor guides light from the two directions. A sensor receives the light from the two directions and is able to discern between the glare light and the ambient light, by filtering the light received from each direction based on color. One color is received from one location and not from the other. The sensor is sensitive to wavelengths and can identify the magnitude of flux received in each color. This allows the interior rearview mirror to identify situations that are appropriate for dimming the electrochromic mirror glass.

### CROSS REFERENCE TO RELATED APPLICATIONS

This application is a continuation of U.S. patent application Ser. 11/144,457, filed on Jun. 3, 2005, which claims priority to German Patent Application No. 10 2004027 611.0 filed on Jun. 5, 2004.

### BACKGROUND ART

1. Field of the Invention

The invention relates to a control circuit for dimming electrochromic mirror glass of a rear view mirror of a motor vehicle. More particularly, the invention relates to a circuit comprising a sensor which produces a signal as a function of a plurality of supplied luminous fluxes from different directions.

2. Description of the Related Art

Control circuits for interior rearview mirrors of motor vehicles are known, wherein the mirror housing is provided with two sensors, one sensor of which detects the glare coming from the vehicle traveling behind and the other sensor detects the ambient light. The two sensors require complex control in order to dim the electrochromic mirror glass to identify glare and measure the intensity of the glare as a function of the ambient light.

An underlying aim of the invention is to develop the generic control circuit in such a way that simple and reliable function is ensured.

### SUMMARY OF THE INVENTION

This aim is addressed by the invention with a control circuit of the generic type in which the control circuit has at least one light conductor whose light receiving side is preceded by a color filter and which is arranged to supply filtered luminous flux to the sensor, which is a color sensor.

As a result of the arrangement according to the invention, a portion of the luminous flux is blocked on its passage through the color filter. The luminous flux filtered in this way is supplied to the sensor by the light conductor. With the light conductor the light can be reliably supplied to the sensor, which converts the filtered luminous flux into an electrical signal.

Advantageously, at least two luminous fluxes from at least two light sources are supplied by means of one light conductor in each case to the color sensor. Both light conductors which are tuned to various wavelengths are preceded in each case by a color filter.

Advantageously, the control circuit according to the invention is used to manipulate the electrochromic mirror glass of vehicle rearview mirrors. Here, the luminous flux coming from the glare of a vehicle traveling behind as well as the luminous flux coming from ambient light after being filtered by the light conductors is supplied to the color sensor. This evaluates the light signals and produces a signal, in order to dim the electrochromic mirror glass as soon as the luminous value drops below a critical parameter.

Since only one sensor is provided, the technical complexity of the control circuit can be kept to a minimum. The rearview mirror can be an interior and/or an external rearview mirror of a motor vehicle. Further components such as a heater for the mirror glass, an antenna, loudspeaker, means of illumination for reading and/or interior lighting, a compass, a display device, a flashing light, parts of a garage door opener, a GPS module and the like can be provided in or on the housing of these rearview mirrors. These components can be arranged in any arbitrary combination. As further applications monitoring systems, which monitor various light sources instead of measuring the operating voltage or operating current, can be provided.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a side view of a rearview mirror of a motor vehicle incorporating one embodiment of the invention;

FIG. 2 is a schematic illustration of a control circuit according to the invention of the rearview mirror of FIG. 1; and

FIG. 3 is an enlarged and exploded view of the sensor of FIG. 1.

### DETAILED DESCRIPTION OF THE PREFERRED EMBODIMENT

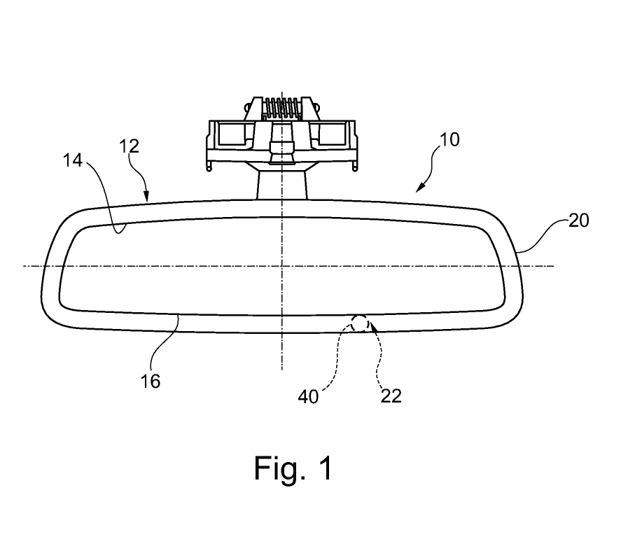

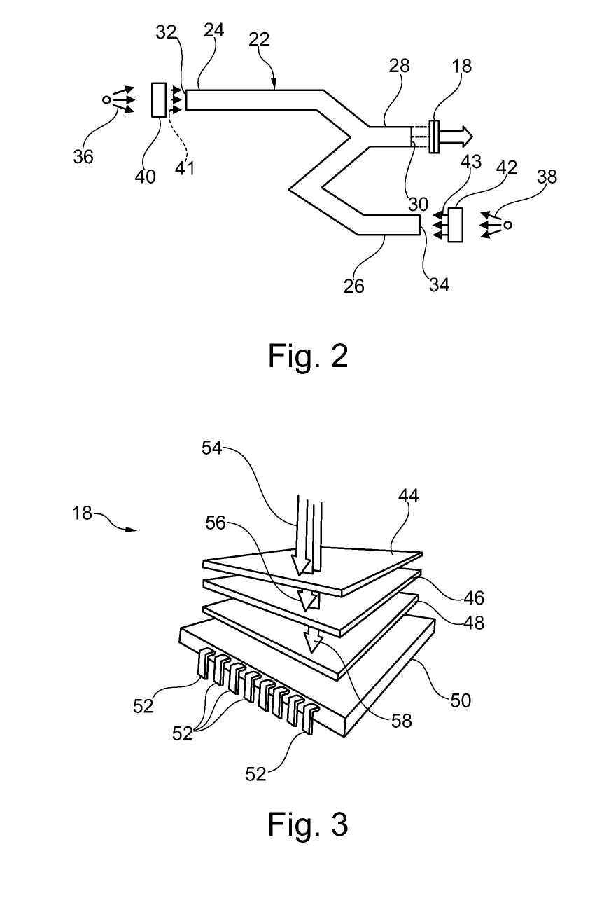

FIG. 1 shows an interior rearview mirror 10 of a motor vehicle, which has a housing 12 with a housing opening 14 for electrochromic (EC) mirror glass 16. In order to prevent the driver from being dazzled by the light from a vehicle traveling aft, a sensor 18 (not shown in FIG. 1) is incorporated in a frame 20 of the housing 12 that defines the housing opening 14 for the EC mirror glass 16. On detecting glare, a control signal is generated, whereby the EC mirror glass 16 is dimmed in the known way, so that the driver is not dazzled. The sensor 18 can of course also be incorporated at any random place in the mirror housing 12 or in the vehicle interior.

The sensor 18 is sensitive to light having specific wavelengths in the visible spectrum of electromagnetic radiation and converts the luminous flux supplied thereto into an electrical signal. The sensor 18 is part of a control circuit 22. The control circuit 22 receives the lumens and guides them to the sensor 18, which generates an electrical signal to control the EC mirror glass 16. Two light conductors 24, 26 direct light toward the sensor 18. The two light conductors 24, 26 are separate and distinct arms in the control circuit 22, but join or merge into one another to form a single trunk 28.

A light exit face 30 of the single trunk 28 lies opposite the sensor 18. The first 24 and second 26 light conductors have first 32 and second 34 light receiving faces, respectively. The first 24 and second 26 light conductors are arranged so that their light receiving surfaces 32, 34 are directed to the rear and to the front in the driving direction of the vehicle, respectively. A first light, or glare, 36 created by the vehicle traveling aft is received by the first light receiving surface 32 directed to the rear, while the second light receiving surface 34 is directed toward the front and detects a second light 38. In this embodiment, the second light 38 is ambient light. The electromagnetic radiation supplied to the sensor 18 by both light conductors 24, 26 through the single trunk 28 includes both the ambient light 38 and the glare 36. Depending on the intensity of the combined luminous flux received by the sensor 18, the EC mirror glass 16 is dimmed to a greater or lesser extent.

So the sensor 18 can separate the glare 36 and the ambient light 38, the first 32 and second 34 light receiving surfaces have first 40 and second 42 color filters arranged in the region therebefore, respectively. The color filters 40, 42 are selected in such a way that they allow light of a certain wavelength and/or with a certain wavelength range to pass through to the downstream light conductors 32, 34. The first color filter 40 creates a first filtered light 41 from the glare 36 that impinges thereon, whereas the second color filter 42 creates a second filtered light 43 from the ambient light 38 that impinges thereon. The wavelengths of the first 41 and second 43 filtered lights differ from each other. The glare 36 and ambient light 38 are therefore differentiated by separation of the spectral ranges. The sensor 18 compares the two filtered lights to determine when it is appropriate to dim the EC mirror glass 16.

By way of example, the first color filter 40 only allows light of the wavelengths which mainly correspond to the color green to pass through. The second color filter 42 is designed for a wavelength range which just blocks the green portion, having been allowed through by the first color filter 40.

Continuing with this example, the sensor 18 subsequently evaluates the luminous fluxes which have been filtered and supplied by the first 24 and second 26 light conductors. The values for the color green in the embodiment are assigned to the luminosity of the glare 36, whereas the values of the other color portion are correlated to the ambient light 38. It should be appreciated by those skilled in the art that any color scheme may be used as long as the colors filtered by the first color filter 40 and the second color filter 42 are mutually exclusive.

The working principle of the control circuit 22 therefore consists of superimposing the light from the two (or more) light sources 36, 38 to the sensor 18 via the first 24 and second 26 light conductors and subsequently through the single trunk 28. Before the glare 36 and ambient light 38 enters the light conductors 24, 26, it is reduced by the color filters 40, 42 to the particular spectral portions.

The sensor 18 is a full color sensor in the form of an X3-CMOS image converter. Referring to FIG. 3, it has three silicon layers 44, 46, 48, in which photodiodes sensitized to the primary colors red, green and blue are embedded. Silicon allows light waves to penetrate the material at a varying degree of depth depending on the color. Thus, blue light is completely absorbed nearly on the surface, i.e., the first silicon layer 44, green light just below it at the second silicon layer 46 and red light below that at the third silicon layer 48. The result is that each individual pixel of the sensor 18 detects the blue, green and red value for each pixel. The layers 44, 46, 48 lie on a carrier 50, which is equipped with connector pins 52.

In FIG. 3, the blue light is represented by arrow 54, green by arrow 56 and red by arrow 58. The blue light is absorbed by the first silicon layer 44 on the surface of the sensor 18, the green light 56 by the middle silicon layer 46 and the red light 58 by the third silicon layer 48. Due to this construction of the sensor 18, the luminous fluxes supplied by the light conductors 24, 26 can be simply and accurately evaluated. In this embodiment, the sensor 18 can assign the values for the color green to the luminosity of the glare 36 and the values for the other colors to the luminosity of the ambient light 38.

The sensor 18 sends corresponding signals via connector pins 52 to a control unit (not shown), which dims the EC mirror glass 16 to the necessary extent, if a critical luminous value for the glare 36 is exceeded. In the same way, the EC mirror glass 16 lightens again, if the critical luminous value of the glare 36 is not reached. The sensor 18 sends a corresponding signal via the connector pins 52 to the control unit.

The color filters 40, 42 are designed so that overlapping of the wavelengths of the light does not occur. Thus, the various light sources 36, 38 can be reliably differentiated from each other.

The color filters 40, 42 are constructed in the known way. The light conductors 24, 26 are formed so that they catch the light of the respective light source 36, 38 without light of the other light source to be detected falling on the improper light receiving surface 32, 34.

With the arrangements described, the luminosity of the ambient light 38 and glare 36 can be simply determined using only one sensor 18 and thus in a constructively simple way optimum dimming of the EC mirror glass 16 is achieved.

In place of the RGB sensor 18 described, a sensor can also be used, whose pixels are subject to a color mosaic filter. In this case, the pixels only detect one of the primary colors red, green or blue. The actual color of the pixel is determined by relating to the adjacent pixels. Also such an RGB sensor can evaluate the supplied luminous fluxes and assign the corresponding luminous values to the light sources 36, 38. If the luminosity of the glare 36 exceeds a critical parameter, the sensor 18 produces a signal for dimming the EC mirror glass 16.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

1.-8. (canceled)

9. A method of dimming an electrochromic mirror glass comprising:
filtering a first light to create a filtered first light;
transmitting the filtered first light to a sensor;
filtering a second light to create a filtered second light;
transmitting the filtered second light to the sensor;
measuring a first luminous flux of the filtered first light;
measuring a second luminous flux of the filtered second light;
comparing the first and second luminous fluxes to create a luminous flux difference; and
dimming the electrochromic mirror glass when the luminous flux difference exceeds a predetermined value.

10. A method as set forth in claim 9 wherein the step of filtering the first light includes the step of filtering the first light by a first wavelength.

11. A method as set forth in claim 10 wherein the step of filtering the second light includes the step of filtering the second light by a second wavelength differing from the first wavelength.
